(19) United States
(12) Patent Application Publication
(10) Pub. No.: US 2010/0258204 A1
(43) Pub. Date: Oct. 14, 2010

(54) Device for Detecting Leaks of Fluids

(75) Inventor: Giovanni Cipolla, Cremona (IT)

Correspondence Address: SHOEMAKER AND MATTARE, LTD, 10 POST OFFICE ROAD - SUITE 100, SILVER SPRING, MD, 20910, US

(73) Assignee: Enolgas Bonomi S.p.A., Concesio (IT)

(21) Appl. No.: 12/759,812

(22) Filed: Apr. 14, 2010

(30) Foreign Application Priority Data
Apr. 14, 2009 (IT) BS2009A000070

(51) Int. Cl. F17D 5/06; F16K 31/02; F16K 17/20; G08B 21/00

(52) U.S. Cl. 137/460; 137/487.5; 340/605

(57) ABSTRACT

A device for detecting leaks of fluids includes means for metering flow of a fluid towards a premises, shut-off means for the fluid, operable between a delivery configuration of the fluid and a closed configuration to allow/prevent its transit towards the premises, and a management and control unit, able to act in conjunction with the metering means of the flow and to send a signal to the shut-off means to switch from the delivery to the closed configuration. The management and control unit comprises enabling means, able to allow or prevent the signal to be sent to the shut-off means. The device comprises, in addition, means for detecting the presence of a user in the premises, operatively connected to the enabling means in such a way that these allow the signal to be sent to the switch if the presence detector means detect the absence of the user in the premises.

### FIELD OF THE INVENTION

The present invention relates to a device for detecting the leakage of fluids, such as hydraulic fluids.

### DESCRIPTION OF THE PRIOR ART

The use of systems to detect leaks of fluid, especially hydraulic, in the home is known of.

The active systems are usually composed of a flow meter, able to send a signal to stop the delivery of water when the flow of the same is above a certain preset value, and by at least one solenoid or motorised valve to shut off the water, commanded by the signals of the flow meter between a configuration in which water is delivered and a closed configuration to allow/prevent transit of the same towards a premises.

The known systems present a number of drawbacks however.

In particular, such systems are programmed to react to an anomalous leak in a single mode only, that is to say by emitting an alarm signal or stopping the water delivery.

It is therefore not unusual, during ordinary daily events, such as when the shower and the dishwasher or irrigation system of the garden are in contemporary use, for the systems to inopportunely stop the water delivery, mistakenly interpreting such increased demand of water as the breakage of a pipe.

### SUMMARY OF THE INVENTION

The present invention therefore sets out to resolve the drawbacks of the prior art and, in particular, those mentioned above.

Such purpose is achieved by a device for detecting leaks of, for example, hydraulic fluids, comprising:
metering means of the flow of a fluid towards a premises, such as a habitation;
shut-off means of the fluid, operable between a delivery configuration of the fluid and a closed configuration to allow/prevent its transit towards the premises; and
a management and control unit, able to act in conjunction with the metering means of the flow and to send the shut-off means a signal to switch from the delivery to the closed configuration;
   wherein the management and control unit comprises enabling means, able to allow/prevent sending of the switch signal to the shut-off means;
   wherein the device comprises, in addition, presence detector means of a user in the premises, operatively connected to the enabling means in such a way that these enable the switch signal to be sent if the presence detector means detect the absence of the user on the premises.

### BRIEF DESCRIPTION OF THE DRAWINGS

FIG. 1 shows a block diagram of the device which the invention relates to, according to one possible embodiment.

FIG. 2 shows a schematic diagram of the disposition of the flow detection devices and shut-off devices, according to an advantageous embodiment of the invention and wherein the arrow shows the direction of transit of the fluid.

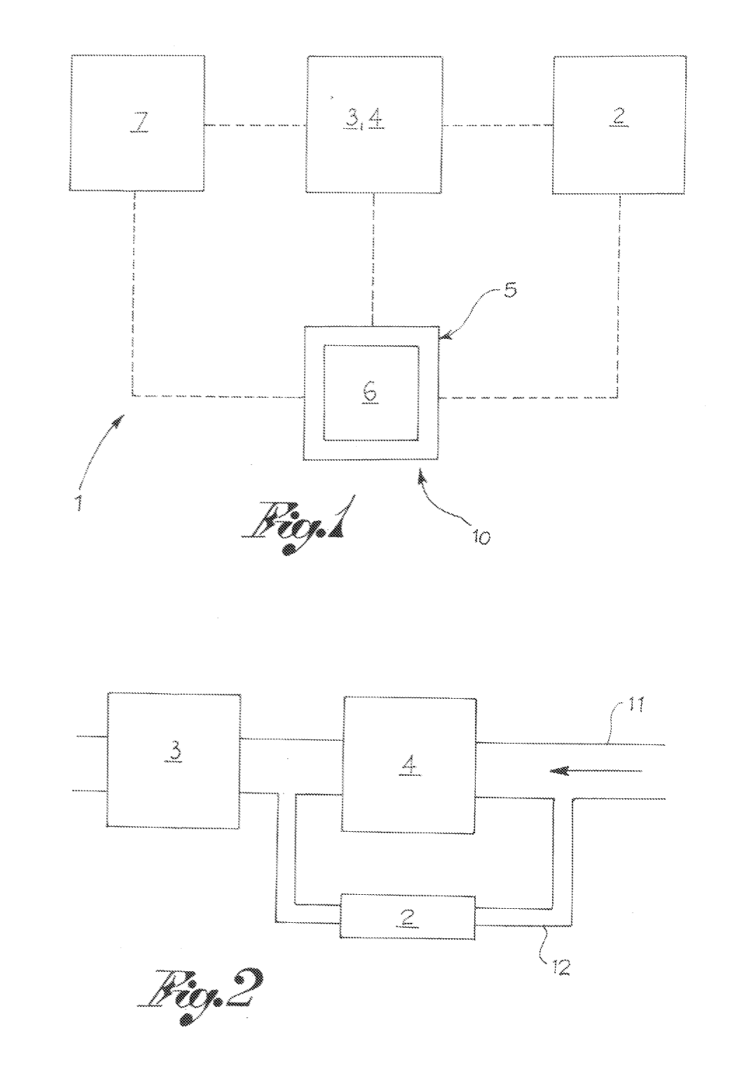

### DETAILED DESCRIPTION OF THE PREFERRED EMBODIMENTS

With reference to the attached drawings, reference numeral 1 globally denotes, in its entirety, a device for detecting leaks of fluid, such as hydraulic leaks.

Preferably, the device 1 is suitable for detecting water leaks, for example domestic.

The device 1 comprises metering means 2 of the flow of a fluid towards a premises, such as a habitation.

According to a preferred embodiment, the metering means 2 of the flow comprise at least one turbine which, moved by the transit of the fluid, generates electric signals received by a management and control unit 5.

Advantageously, the metering means 2 of the flow comprise a micro-flow detector, that is to say a detector able to detect small flows of fluid, to the order of 1 litre/hour.

This way, advantageously, the device according to such variation is able to detect even small leaks from a circuit, such as those caused by a dripping tap, and not just big flows caused by a broken pipe.

The device 1 comprises in addition shut-off means 3, 4 of the fluid, which can be activated between a delivery configuration of the fluid and a closed configuration to allow/prevent its transit towards the premises.

In other words, when the shut-off means 3, 4 are positioned in the delivery configuration of the fluid, they identify a route for the passage of the fluid towards the premises. When, rather, they are positioned in the closed configuration, the fluid is prevented from transiting towards the premises.

Preferably, the shut-off means 3, 4 of the fluid comprise at least one motorised valve 3, solenoid valve or similar, and/or a check valve 4.

Even more preferably, the shut-off means 3, 4 comprise a motorised valve 3 and a check valve 4, such as illustrated in the schematic diagram in FIG. 2.

According to one possible variation, the shut-off means 3, 4 are positioned downstream of the metering means 2 of the flow in the direction of transit of the fluid.

According to one advantageous variation, the shut-off means 3, 4 are positioned on a first duct 11, the metering means 2 of the flow are positioned on a second duct 12 in fluidic connection with the first, the latter having a greater through section than the second duct 12.

In other words, according to this embodiment, the second duct 12, which the metering means 2 are positioned on, acts as a by-pass in relation to the first delivery duct 11 of the fluid, achieving a dual advantage.

The first advantage lies mainly in the fact that, the second duct 12 having a smaller through section than the first 11, the metering means 2 positioned on it are more sensitive to detecting small capacity flows.

In addition, for the embodiments which envisage a check valve 4, positioned on the first duct 11 and by-passed by the second duct 12, it is mainly such valve which receives the oscillation resonances of the fluid at the end of each delivery, and not the metering means 2, as happens rather in the devices of the prior art.

This way, advantageously, the metering means 2 do not run the risk of generating false detection of leaks of the fluid caused by the aforesaid resonance.

The device 1 comprises, in addition, a management and control unit 5, able to act in conjunction with the metering means 2 of the flow and to send the shut-off means 3, 4 a signal to switch from the delivery to the closed configuration.

In other words, when the metering means 2 of the flow detect a transit of fluid, such as through the turbine, they send a signal to the management and control unit 5 which, in turn, sends a signal to the shut-off means 3, 4 to switch from the delivery to the closed configuration, preventing transit of the fluid towards the premises.

According to one advantageous variation, the management and control unit 5 comprises at least one microprocessor, to process the signal coming from the metering means and from the presence detector means 7, and to formulate a counter measure, if deemed necessary.

According to a further advantageous variation, the management and control unit 5 comprises alarm devices, such as a siren, and means of communication, for example towards a user, to signal an anomalous situation.

This way, advantageously, the device which the invention relates to is able to warn a user in any circumstances, whether on the premises or elsewhere, for example by sending an SMS or making an emergency call to the user's mobile or to an emergency service number.

According to one embodiment variation, the means of communication comprise a telephone module, such as a GSM.

The management and control unit 5 comprises enabling means 6, able to allow/prevent sending of the switch signal to the shut-off means 3, 4.

In other words, the enabling means 6 act as a filter of the switch signal towards the shut-off means 3, 4, that is the enabling means 6 use advanced criteria, of which more will be the later, to establish the effective need to position the shut-off means 3, 4 in the closed configuration.

Consequently, advantageously, the interruption of the delivery of the fluid towards the premises cannot occur inadvertently, as a result of an episodic increased demand of fluid.

In fact, the enabling means 6 make it possible to reduce the occurrence of false alarms and, as a result, inconvenience to the user.

The device 1 comprises lastly, presence detector means 7 of a user in the premises, operatively connected to the enabling means 6 so that this allows the switch signal to be sent if the presence detector means 7 detect absence of a user in the premises.

Consequently, in the absence of the user inside the premises, when the metering means 2 detect a delivery of the fluid, such as below or above a pre-set threshold, they send a signal to the management and control unit 5.

In response to such signal, the management and control unit 5 prepares to send the switch signal to the shut-off means 3, 4. However, for the switch signal to be effectively sent, the enabling means 6 need to have been enabled to send a signal by the presence detector means 7, which detect the presence or absence of the user on the premises.

Consequently, if the presence detector means 7 detect that there is a user on the premises, the switch signal is blocked by the enabling means 6.

For the embodiments envisaging such, the management and control unit 5 can, if necessary, activate the alarm devices, for example warning the user by means of a siren positioned on the premises.

According to a further variation, if the presence detector means 7 detect that there is a user on the premises, subsequent to blocking of the switch signal by the enabling means 6, the device 1 does not take any further action.

Vice versa, if the presence detector means 7 detect the absence of the user on the premises, the enabling means 6 allow the switch signal to be sent to the shut-off means 3, 4, which position themselves in the closed configuration, stopping delivery of the fluid.

Furthermore, for the embodiments envisaging such, the management and control unit 5 can send a signal to the means of communication, which deals with sending an emergency call or SMS to alert, for example the user, a watchman or an emergency service number.

According to one embodiment variation, the presence detector means 7 comprise movement sensor devices, for example volumetric.

According to a further variation, the movement sensor devices are of the infra-red, microwave or combined type, such as the type typically used in anti-intrusion or security systems.

Advantageously, this way, the device which the invention relates to is able to interface with devices probably already present on the premises, such as the sensors of a conventional alarm system.

Preferably, the presence detector means 7 are in wireless communication with the management and control unit 5.

This way, advantageously, the installation of the device which the invention relates to does not entail making special raceways for the passage of cables converging towards the management and control unit, or the unattractive presence of wires for the transit of the signals.

Preferably the enabling means 6 comprise, in addition, a timer device which, when the presence detector means 7 detect the absence of the user on the premises, is able to send the switch signal in the case in which the delivery of fluid is contrary to pre-set temporal or flow criteria for example.

Consequently, when the presence detector means 7 detect the absence of the user on the premises, the timer device acts as a supplementary filter to sending of the switch signal, sending such signal conditional to verification of the pre-set criteria.

If, for example, the user turns on a dishwasher or a washing machine before leaving the premises, in the absence of the timer device, the enabling means 6, having ascertained the absence of the user, send the switch signal to the shut-off means 3, 4.

However, the timer device is able to verify if the delivery of fluid, detected by the metering means 2, is compatible with the delivery of water used by a dishwasher, in that such delivery occurs, for example, at regular intervals compatible with the filling and rinsing phases.

According to a further example, the timer device is programmable so as to block the switch signal in the case in which a system is provided for watering the garden, active at certain times of the day, not necessarily coinciding with the presence of the user on the premises.

Preferably, the device 1 comprises, in addition, a seismic detection device, able to detect telluric quakes, operatively connected to the management and control unit 5.

Consequently, the seismic detection device is able to send a danger signal to the management and control unit 5, the size of which is assessed by the latter, which deals with sending the switch signal in the case in which there is a risk of the pipes breaking.

Advantageously, this way, the device which the invention relates to is able to ensure the safety of the premises, including in relation to natural events.

According to embodiment variations of the invention, the seismic detection device comprises a geophone, a seismometer, a vertical sensor, a simple suspension, a Lacoste suspension and/or leaf spring suspension, a long or short-period horizontal sensor, and/or a force-feedback sensor.

Preferably, the seismic detection device comprises an accelerometer, for example with an electronic detection circuit.

Even more preferably, the device 1 comprises, in addition, a heat detection device, able to detect the temperature of the fluid, operatively connected to the management and control unit 5.

In other words, the heat detection device, for example a thermometer, a thermocouple or similar, is able to check that the temperature of the fluid does not fall below its melting temperature, making it solid and causing the potential bursting of pipes, for example if the fluid should freeze and thereby increase in volume.

According to one embodiment variation, the device 1 comprises, in addition, a damp and/or wetness sensor device operatively connected to the management and control unit 5.

Preferably, the damp and/or wetness sensor is positioned at the main fluidic and preferably water utilities on the premises, such as in the bathrooms and/or kitchen.

Advantageously, the damp and/or wetness sensor device is able to detect leaks on the premises not detectable by the metering means 2, in as much as only indirectly linked to the delivery of water.

Imagine for example a leak from the storage tank of a boiler or an immersion heater, where the leakage of liquid may not result in the delivery of further liquid, measurable by the metering means 2. For example, this would be the case in which the supply valve of the liquid to the storage tank were closed.

The present invention relates, in addition, to a method for detecting leaks of, for example, hydraulic fluids.

Such method comprises the phases of measuring the flow of a fluid to a premises, detecting the presence of a user on the premises, sending a signal to the shut-off means 3, 4 of the fluid to switch from a delivery configuration of the fluid to a closed configuration to prevent the transit of the fluid to the premises, if the absence of the user on the premises is detected, and to switch the shut-off means 3, 4 from the delivery configuration of the fluid to the closed configuration.

According to one advantageous variation of the method, the phase of switching the shut-off means 3, 4 is preceded by a phase of verifying that the deliveries of fluid are contrary to pre-set temporal or flow criteria for example.

According to a further variation, the phase of detecting the presence of a user comprises a phase of detecting their movement, for example volumetrically.

According to yet a further variation the method comprises, in addition, a detection phase of telluric quakes, and/or a detection phase of the temperature of the fluid.

The present invention also relates to an IT product which can be directly loaded into the internal memory of a processing unit and comprising portions of software code able to enact a method of detecting leaks of fluids according to any of the previous embodiments, when the portions of software code are run by the processing unit.

The present invention relates lastly to a detection group 10 of leaks of, for example, hydraulic fluids, comprising a management and control unit 5 able to act in conjunction with metering means 2 of the flow of a fluid to a premises and to send a signal to the shut-off means 3, 4 of the fluid to switch from a delivery configuration of the fluid to a closed configuration to prevent the transit of the fluid to the premises.

The management and control unit 5 comprises enabling means 6, able to allow/prevent sending of the switch signal to the shut-off means 3, 4 of the fluid.

In addition, the enabling means 6 can be operatively connected to the presence detector means 7 of a user in the premises, in such a way that the enabling means 6 permit the switch signal to be sent if the presence detector means 7 detect the absence of the user on the premises.

Innovatively, the device which the invention relates to makes it possible to avoid creating false alarms relative to leaks or dripping by detecting the presence of a user on the premises where the fluid is delivered.

A person skilled in the art may make variations to the aforesaid embodiments of the device, of the group and of the method for detecting leaks and substitute elements with others functionally equivalent so as to satisfy specific requirements.

Such variations also remain within the sphere of protection as defined by the appended claims.

Moreover, each variation described as belonging to a possible embodiment may be realised independently of the other variations described.

1. A device for detecting leaks of, for example, hydraulic fluids, comprising:
metering means of the flow of a fluid towards a premises, such as a habitation;
shut-off means of the fluid, operable between a delivery configuration of the fluid and a closed configuration to allow/prevent its transit towards the premises; and
a management and control unit, able to act in conjunction with the metering means of the flow and to send the shut-off means a signal to switch from the delivery to the closed configuration;
wherein the management and control unit comprises enabling means, able to allow/prevent sending of the switch signal to the shut-off means; wherein the device comprises, in addition, presence detector means of a user in the premises, operatively connected to the enabling means in such a way that these enable the switch signal to be sent if the presence detector means detect the absence of the user on the premises.

2. Device according to claim 1, wherein the enabling means comprise a timer device which, when the presence detector means detect the absence of the user on the premises, is able to send the switch signal in the case in which the deliveries of fluid are contrary to pre-set temporal or flow criteria for example.

3. Device according to claim 1, wherein the presence detector means comprise movement sensor devices, for example volumetric.

4. Device according to claim 1, wherein the metering means of the flow comprise at least one turbine which, moved by the transit of the fluid, generates electric signals received by the management and control unit.

5. Device according to claim 1, wherein the shut-off means of the fluid comprise at least one motorised valve, solenoid valve or similar, and/or check valve.

6. Device according to claim 1, wherein the management and control unit comprises at least one microprocessor, alarm device and means of communication, such as towards a user, to signal an anomalous situation.

7. Device according to claim 1, comprising, in addition, seismic detection devices, able to detect telluric quakes, operatively connected to the management and control unit.

8. Device according to claim 1, comprising, in addition, heat detection devices, able to detect the temperature of the fluid, operatively connected to the management and control unit.

9. Device according to claim 1, wherein:
the shut-off means are positioned on a first duct;
the metering means of the flow are positioned on a second duct in fluidic connection with the first;
the first duct having a bigger through section than the second duct.

10. Device according to claim 1, comprising:
seismic detection devices, able to detect telluric quakes, operatively connected to the management and control unit;
heat detection devices, able to detect the temperature of the fluid, operatively connected to the management and control unit; and wherein
the shut-off means are positioned on a first duct;
the metering means of the flow are positioned on a second duct in fluidic connection with the first; the first duct having a bigger through section than the second duct.

11. A device for detecting leaks of, for example, hydraulic fluids, comprising:
metering means of the flow of a fluid towards a premises, such as a habitation;
shut-off means of the fluid, operable between a delivery configuration of the fluid and a closed configuration to allow/prevent its transit towards the premises; and
a management and control unit, able to act in conjunction with the metering means of the flow and to send the shut-off means a signal to switch from the delivery to the closed configuration; wherein
the shut-off means are positioned on a first duct,
the metering means of the flow are positioned on a second duct in fluidic connection with the first duct, and
the first duct has a bigger through section than the second duct.
